(19) United States
(12) Patent Application Publication
(10) Pub. No.: US 2025/0279738 A1
(43) Pub. Date: Sep. 4, 2025

(54) METHOD OF CONTROLLING A BRUSHLESS PERMANENT MAGNET MOTOR

(71) Applicant: Dyson Technology Limited, Malmesbury, Wiltshire (GB)

(72) Inventor: Naveed ur Rehman MALIK, ur Swindon (GB)

(21) Appl. No.: 18/858,789

(22) PCT Filed: Apr. 24, 2023
(86) PCT No.: PCT/GB2023/051080

§ 371 Date: Oct. 22, 2024

(30) Foreign Application Priority Data
Apr. 26, 2022 (GB) 2206048.7

(51) Int. Cl. H02P 6/185

(52) U.S. Cl. CPC H02P 6/185

(57) ABSTRACT

A method of controlling a brushless permanent magnet motor is provided. The method includes sequentially exciting and freewheeling a phase winding of the motor over a time interval between successive commutations of the phase winding. Exciting the phase winding includes applying a voltage to the phase winding. Freewheeling includes freewheeling the phase winding for a respective freewheel period in response to a phase current flowing through the phase winding reaching a current threshold. The method further includes determining the freewheel period such that the freewheel period increases between a start of the time interval and an end of the time interval.

### FIELD OF THE INVENTION

The present invention relates to a method of controlling a brushless permanent magnet motor.

### BACKGROUND OF THE INVENTION

Knowledge of position of a rotor of a brushless motor is important in order to commutate the phase windings of a brushless motor at the correct times. A permanent-magnet motor will often include a Hall-effect sensor, which outputs a signal indicative of the rotor position. Although the component cost of the sensor is relatively cheap, integrating the sensor within the motor often complicates the design and manufacture of the motor. Additionally, the signal output by the sensor is often susceptible to electromagnetic noise generated within the motor.

Sensorless schemes for determining indirectly the position of a rotor are known. For a permanent-magnet motor, transitions in the polarity of the back EMF induced in a phase winding may be used to determine the rotor position. However, since the magnitude of the back EMF is proportional to the speed of the rotor, transitions in the polarity of the back EMF cannot always be reliably determined at low speeds.

### SUMMARY OF THE INVENTION

According to a first aspect of the present invention there is provided a method of controlling a brushless permanent magnet motor, the method comprising: sequentially exciting and freewheeling a phase winding of the motor over a time interval between successive commutations of the phase winding, wherein exciting the phase winding comprises applying a voltage to the phase winding, and freewheeling comprises freewheeling the phase winding for a respective freewheel period in response to a phase current flowing through the phase winding reaching a current threshold; and determining the freewheel period such that the freewheel period increases between a start of the time interval and an end of the time interval.

Schemes in which phase windings are sequentially excited and freewheeled, with freewheeling occurring in response to current in the phase winding reaching a threshold, and in which parameters relating to the current are monitored, have previously been proposed. It has been recognised that, due to hardware configurations and delays, residual currents in the phase winding from one excitation to the next may lead to current spikes where current in the phase winding exceeds the current threshold. This may permanently demagnetise the rotor magnet resulting in loss of performance.

By determining the freewheel period such that the freewheel period increases between a start of the time interval and an end of the time interval, residual current in the phase winding may be reduced, which may reduce the risk of current spikes occurring, and provide a flatter current profile across the time interval. This may lead to increased motor reliability, and may improve battery lifetime and battery run time where the brushless permanent magnet motor is implemented in a battery operated product, for example a vacuum cleaner or a haircare appliance.

Utilising control methods to account for current spikes may be less costly than modifying hardware, which may reduce a cost of the brushless permanent magnet motor relative to an arrangement that utilises hardware to account for current spikes.

Determining the freewheel period may comprise determining the freewheel period such that the freewheel period increases sequentially within the time interval, for example with each successive freewheel period within the time interval increased relative to a previous adjacent freewheel period within the time interval. Such sequential increasing of the freewheel period may aid with providing a relatively flat current profile across the time interval, for example compared to an arrangement in which the freewheel period is increased at irregular intervals within the time period. The freewheel period may be increased by a different amount for each increase of the freewheel period within the time interval.

The method may comprise determining an initial freewheel period within the time interval based at least in part on a DC link voltage applied to the phase winding. A level of the DC link voltage may have a direct impact on a level of current flowing through the phase winding, for example with a higher DC link voltage leading to a higher current level, and so determining the initial freewheel period based at least in part on the DC link voltage may enable the method to account for increased current levels within the phase winding. A higher initial freewheel period may be determined for a relatively high DC link voltage, and a lower initial freewheel period may be determined for a relatively low DC link voltage. The initial freewheel period may be determined based at least in part on a gradient change of the freewheel period with DC link voltage. The gradient change of the freewheel period with DC link voltage may be determined at least in part by experimental and/or simulation data.

A difference between a previously determined freewheel period and a next sequential freewheel period may increase within the time interval, for example such that an amount of increase in freewheel period increases along the time interval. This may help mitigate for increasing levels of current spikes along the time interval.

The difference may be determined based at least in part on a time at which the next sequential freewheel period occurs within the time interval. The difference may be determined at least in part on a gradient change of the freewheel period with time. The gradient change of freewheel with time may be determined at least in part by experimental and/or simulation data.

The method may comprise, within the time interval, measuring for each excitation of the phase winding, a parameter that depends on a rate of change of current in the phase winding during excitation or freewheeling; comparing a most recent parameter to a previous sequential parameter; where a difference between the most recent measured parameter and the previous sequential parameter is below a threshold value, determining that a rotor of the brushless permanent magnet motor is at a pre-determined position; and in response to determining that the rotor is at the predetermined position, commutating the phase winding.

For example, the parameter may be the magnitude of current at the start or end of freewheeling, or the parameter may be the time required for current to rise to the current threshold during excitation (rise-time of current). During rotation, the rotor induces a back EMF in the winding, the magnitude of which depends on the angular position of the rotor. This back EMF influences the rate at which current in the winding rises during excitation and falls during freewheeling.

Consequently, the measured parameter may be used to determine the angular position of the rotor. In particular, a determination may be made that the rotor is at a particular predetermined position when the measured parameter is less than or greater than a threshold.

Thus the method may not rely directly on a measured back EMF to determine the position of the rotor, and the method may be suitable for periods in which the value of back EMF induced in the motor is relatively low, for example during acceleration of the motor from standstill or very low speeds. The method may instead make use of changes in the inductance of the phase winding that arise as the rotor rotates from one aligned position to the next aligned position. As the rotor approaches an aligned position, the inductance of the phase winding decreases. As a result, the rates at which the phase current rises during excitation increase. By appropriate setting of the threshold value, comparison of the most recent measured current rise time and the previous sequential current rise time may be utilised to determined when the rotor is at or near an aligned position, and hence relatively accurate commutation of the motor may be achieved to enable acceleration of the motor to occur.

The method may comprise a method of starting the brushless permanent magnet motor, for example a sensorless method of starting the brushless permanent magnet motor.

The method may comprise, within the time interval; measuring for each excitation of the phase winding, a current rise time between application of the voltage pulse and the phase current reaching the current threshold; comparing a most recent measured current rise time to a previous sequential current rise time; where a difference between the most recent measured current rise time and the previous sequential current rise time is below a threshold value, determining that a rotor of the brushless permanent magnet motor is at a pre-determined position; and in response to determining that the rotor is at the predetermined position, commutating the phase winding.

The method may comprise commutating the phase winding after a waiting period has elapsed from determining that the rotor is at the predetermined position. For example, the pre-determined position may be a position in advance of an aligned position of the rotor. This may ensure that commutation of the motor at the aligned position of the rotor is not missed, for example due to hardware and/or software delays.

The method may comprise sequentially exciting and freewheeling the phase winding of the motor over a plurality of sequential time intervals, each time interval comprising a time interval between successive commutations of the phase winding, wherein a different polarity of voltage pulse is applied to the phase winding in two adjacent time intervals, and at least some freewheel periods of a later one of the two adjacent time intervals are greater than at least some freewheel periods of an earlier one of the two adjacent time intervals. This may enable account to be taken of an increase in speed between two successive time intervals, and hence an increase in back EMF, for example with higher freewheel periods being implemented in a time interval in which the rotor rotates at a higher speed, when compared with lower freewheel periods implemented in a time interval in which the rotor rotates at a lower speed.

A fixed increase may be applied to adjacent freewheel periods within each time interval, with the fixed increase increasing in value between adjacent time intervals. For example, a fixed increase comprising a first value may be utilised in a first time interval, and a fixed increase comprising a second value greater than the first value may be utilised in a second time interval adjacent and sequential to the first time interval.

The method may comprise resetting the freewheel period at the end of each time interval, for example resetting the freewheel period to the initial time interval at the end of each time interval. This may facilitate acceleration of the motor.

The method may occur during acceleration of the brushless permanent magnet motor.

According to a second aspect of the present invention there is provided a brushless permanent magnet motor comprising a phase winding, and a controller configured to perform the method f the first aspect of the present invention. The brushless permanent magnet motor may comprise a single phase brushless permanent magnet motor.

The brushless permanent magnet motor may comprise an inverter and a current sensor, and the current sensor may be located on a low-side of the inverter. The brushless permanent magnet motor may comprise a single current sensor, the single current sensor located on a low-side of the inverter, between low-side switches of the inverter and a ground connection. The method described herein may find particular utility in such an arrangement, as it may not be possible to measure the current flowing through the phase winding during freewheeling. This can lead to the current sensor reading being zero at the end of freewheeling, i.e. at the start of a next excitation pulse, when in practice there is residual current in the phase winding. As the phase current increases during excitation, the reading of the current sensor may be below the actual value of current present in the phase winding, which may mean that by the time the current sensor thinks the current in the phase winding has reached the current threshold, the actual value of current in the phase winding is in fact higher. The method disclosed herein may mitigate this by increasing the freewheel period within the time interval to reduce such current peaks.

Freewheeling may comprise freewheeling around the low-side of the inverter, for example by opening high-side switches of the inverter and closing low-side switches of the inverter.

According to a third aspect of the present invention there is provided a data carrier comprising machine-readable instructions for the operation of one or more controllers of a brushless permanent magnet motor to perform the method according to the first aspect of the present invention.

According to a fourth aspect of the present invention there is provided a vacuum cleaner comprising a brushless permanent magnet motor according to the third aspect of the present invention.

According to a fifth aspect of the present invention there is provided a haircare appliance comprising a brushless permanent magnet motor according to the third aspect of the present invention.

Optional features of aspects of the present invention may be equally applied to other aspects of the invention, where appropriate.

### BRIEF DESCRIPTION OF THE DRAWINGS

Preferred features of the invention will now be described, by way of example only, with reference to the accompanying drawings, in which:

FIG. 1 is a schematic diagram of a brushless permanent magnet motor;

FIG. 2 is a table illustrating allowed states of an inverter in response to control signals issued by a controller of the brushless permanent magnet motor of FIG. 1;

FIG. 3 is a first schematic illustration of current and voltage waveforms using a fixed freewheel period;

FIG. 4 is a second schematic illustration of current and voltage waveforms using a fixed freewheel period;

FIG. 5 is a flow diagram illustrating a method according to the present invention;

FIG. 6 is a first schematic illustration of current and voltage waveforms using a variable freewheel period;

FIG. 7 is a second schematic illustration of current and voltage waveforms using a variable freewheel period;

FIG. 8 is a schematic view of a vacuum cleaner comprising the brushless permanent magnet motor of FIG. 1; and

FIG. 9 is a schematic view of a haircare appliance comprising the brushless permanent magnet motor of FIG. 1

### DETAILED DESCRIPTION OF THE INVENTION

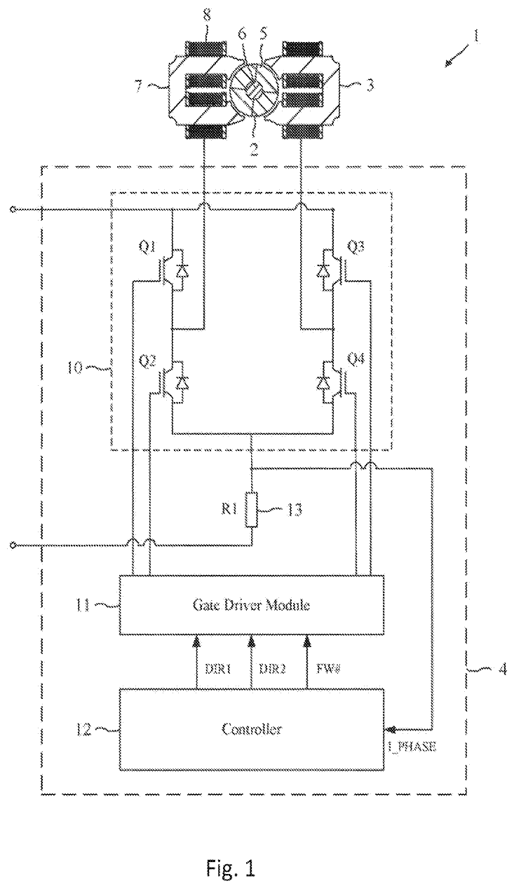

A brushless permanent-magnet motor 1 is illustrated schematically in FIG. 1, and comprises a rotor 2, a stator 3, and a control system 4.

The rotor 2 comprises a four-pole permanent magnet 5 secured to a shaft 6. The stator 3 comprises a pair of cores 7 having four salient poles, and a phase winding 8 wound about the cores 7. The control system 4 comprises an inverter 10, a gate driver module 11, a controller 12, and a current sensor 13. The inverter 10 comprises a full bridge of four power switches Q1-Q4 that couple the phase winding 8 to the voltage rails of a power supply (not shown).

The gate driver module 11 drives the opening and closing of the switches Q1-Q4 in response to control signals output by the controller 12.

The controller 12 is responsible for controlling the operation of the motor 1 and generates three control signals: DIR1, DIR2, and FW #. The control signals are output to the gate driver module 11, which in response drives the opening and closing of the switches Q1-Q4.

When DIR1 is pulled logically high and DIR2 is pulled logically low, the gate driver module 11 closes switches Q1 and Q4, and opens switches Q2 and Q3. As a result, a voltage having a first polarity is applied to the phase winding 8, causing current to be driven through the phase winding 8 from left to right. Conversely, when DIR2 is pulled logically high and DIR1 is pulled logically low, the gate driver module 11 closes switches Q2 and Q3, and opens switches Q1 and Q4. As a result, a voltage having a second, opposite polarity is applied to the phase winding 8, causing current to be driven through the phase winding 8 from right to left. DIR1 and DIR2 therefore control the polarity of the voltage that is applied to the phase winding 8 and thus the direction of current through the phase winding 8. If both DIR1 and DIR2 are pulled logically low, the gate drive module 11 opens all switches Q1-Q4.

When FW # is pulled logically low, the gate driver module 11 opens both high-side switches Q1,Q3. Current in the phase winding 8 then circulates or freewheels around the low-side loop of the inverter 10 in a direction defined by DIR1 and DIR2. Each switch Q1-Q4 conducts in a single direction only but includes a body diode. The current that freewheels around the low-side loop of the inverter 10 therefore flows through one of the low-side switches Q2, Q4 and through the body diode of the other low-side switch Q2,Q4. Certain types of power switch are capable of conducting in both directions when closed. In this instance, when FW # is pulled logically low, both low-side switches Q2,Q4 may be closed such that current flows through both of the switches Q2, Q4 rather than through one of the body diodes.

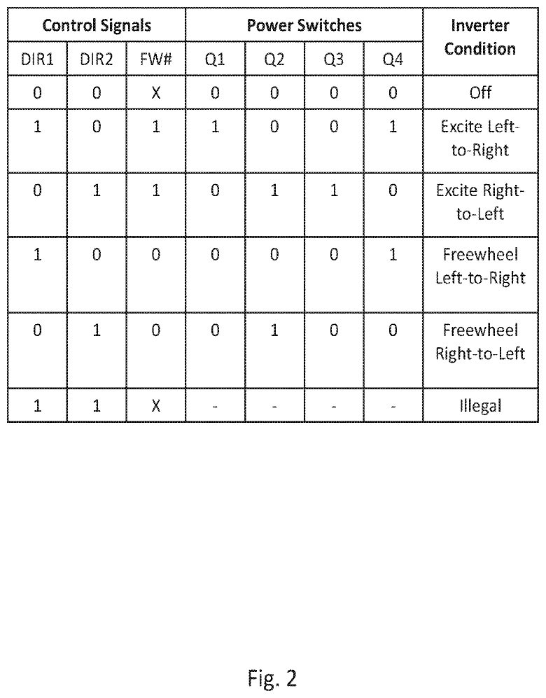

FIG. 2 summarises the allowed states of the switches Q1-Q4 in response to the control signals of the controller 12. Hereafter, the terms ‘set’ and ‘clear’ will be used to indicate that a signal has been pulled logically high and low respectively.

The current sensor 13 comprises a sense resistor R1 located between the inverter 10 and the zero voltage rail. The voltage across the current sensor 13 provides a measure of the phase current (i.e. the current in the phase winding 8) when either DIR1 or DIR2 is set. The voltage across the current sensor 13 is output to the controller 12 as signal I_PHASE.

When the rotor 2 is stationary, the controller 12 excites the phase winding 8 in a predetermined sequence that ensures that, irrespective of the position in which the rotor 2 has parked, the rotor 2 is driven in a forward direction. For example, the controller 12 may employ the start-up scheme described in WO2013/132249.

The particular scheme employed by the controller 12 in order to start the rotor 2 is not pertinent to the present invention.

Once the rotor 2 is moving forwards, the controller 12 employs a control scheme to accelerate the rotor 2. The controller 12 begins by exciting the phase winding 8 in a direction that continues to drive the rotor 2 forwards. So, for example, the controller 12 may set DIR1 and clear DIR2 so as to excite the phase winding 8 from left to right. The particular direction of excitation will depend on the scheme that is employed at start up. During excitation, the controller 12 monitors the magnitude of the phase current via the I_PHASE signal. When the phase current exceeds a current threshold, the controller 12 freewheels the phase winding 8 by clearing FW #. Freewheeling continues for a fixed freewheel period, during which time the phase current decays. At the end of the freewheel period, the controller 12 again excites the phase winding 8 by setting FW #.

The controller 12 thereby sequentially excites and freewheels the phase winding 8. At the end of each freewheel period, the controller 12 starts a timer. When the phase current subsequently exceeds the current threshold, the controller 12 stops the timer and stores the current rise time. The controller 12 compares adjacent sequential current rise times and compares them to one another. If a difference between adjacent sequential current rise times is negative and below a pre-determined threshold value, then it is determined that the stator is saturation, inductance of the stator is falling, and that the rotor 2 is at or approaching an aligned position. In particular, as the rotor approaches an aligned position, the inductance of the phase winding decreases. As a result, the rates at which the phase current rises during excitation and falls during freewheeling increase. By appropriate setting of the pre-determined threshold value, a position at or near the aligned position can be determined.

In some examples the threshold is set such that a position in advance of the aligned position is determined.

The controller 12 then continues to sequentially excite and freewheel the phase winding 8 for a period of time that will hereafter be referred to as the waiting period. The controller 12 therefore monitors the magnitude of the phase current during excitation, and freewheels the phase winding 8 when the phase current exceeds the current threshold. Freewheeling continues for the freewheel period, after which the controller 12 again excites the phase winding 8. However, in contrast to the process described above, the controller 12 no longer stores and compares the current rise times. Instead, the controller 12 continues to excite and freewheel the phase winding 8 until the waiting period has elapsed, at which point the controller 12 commutates the phase winding 8. Commutation involves reversing the direction of current through the phase winding 8. The controller therefore toggles DIR1 and DIR2 and sets FW #. In the present example, DIR1 was set initially such that current was driven through the phase winding 8 from left to right. Commutation therefore involves clearing DIR1, setting DIR2 and setting FW # such that current is now driven through the phase winding 8 in a direction from right to left.

In other examples threshold is set such that an aligned position is determined, and commutation occurs substantially immediately in response to the determination of the aligned position, with commutation implemented in the manner described above.

The period between successive commutations may be referred to as a time interval herein. The same process is then applied over several time periods, with current applied in opposing directions between adjacent sequential time periods, in order to accelerate the rotor 2. Once the rotor 2 reaches a certain speed threshold, steady-state control may be applied. Detail of such steady-state control are not pertinent to the present invention, and so will not be described for the sake of brevity.

In the manner described above, a position of the rotor 2 may be determined without needing to directly measure the back EMF induced in the phase winding 8, and without needing the use of a position sensor, such as a Hall sensor or the like.

However, it has been found that in use of the acceleration method described above, current peaks may be experienced, which can lead to demagnetisation of the permanent magnet 5, and which can be detrimental to run-time and/or cell health of a battery of a product in which the brushless permanent magnet motor 1 is used.

In particular, it has been found that residual current in the phase winding 8 during freewheeling can lead to current spikes during excitation of the phase winding 8.

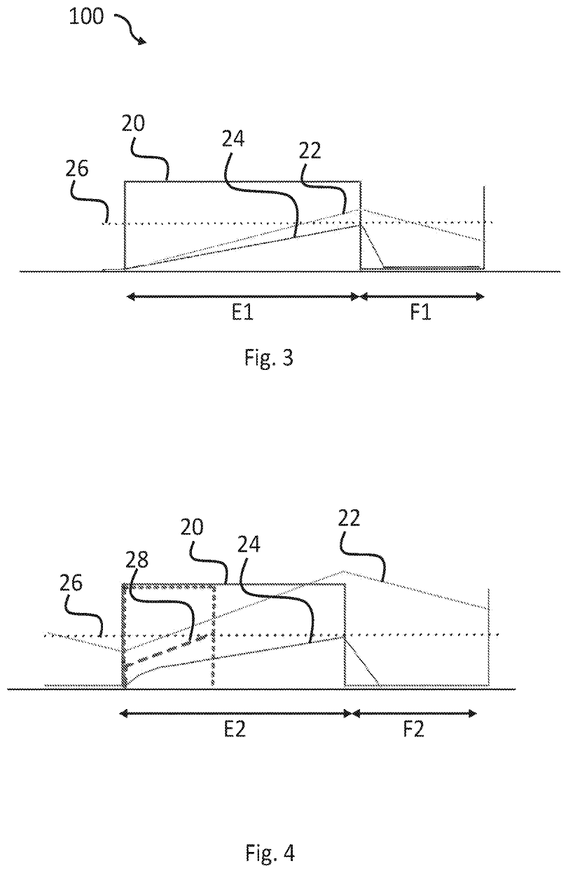

Illustrative voltage and current waveforms for first and second excitation and freewheel periods are shown in FIGS. 3 and 4 respectively.

As can be seen in FIG. 3, when a voltage pulse 20 is applied to the phase winding 8 in a first excitation period E1, phase current 22 in the phase winding 8 rises. A shunt current 24 measured by the current sensor 13 largely follows the phase current 22, although the shunt current 24 increases at a slower rate. When the shunt current 24 hits a current threshold 26, the phase winding 8 is freewheeled for a first freewheel period F1 in the manner previously described. The current sensor 13 is unable to measure current during freewheeling of the phase winding 8, and so the measured shunt current 24 drops to zero in the first freewheel period F1. However, as the phase current 22 freewheels around the low-side of the inverter 10 during the first freewheel period F1, at the end of the freewheel period there is a non-zero residual phase current in the phase winding 8.

Thus, at the start of a subsequent second excitation period E2, illustrated in FIG. 4, the actual measured shunt current 24 is zero, whilst the ideal measured shunt current 28 would be non-zero, and closer to the value of the phase current 22 present in the phase winding 8 at the end of the first freewheel period F1. This may be further compounded by hardware delays, and so, as the voltage pulse 30 is applied to the phase winding 8, the phase current 22 in the phase winding 8 rises to a higher level by the time the shunt current 24 reaches the current threshold, leading to a current spike. Given the higher level of phase current 22 at the end of the second excitation period E2, at hence at the start of a second freewheel period F2, residual phase current in the phase winding is at a higher level at the end of the second freewheel period F2 when compared to the end of the first freewheel period F1. Given the sequential excitation and freewheeling during the time interval, this means that current spikes increase may increase in magnitude over the course of a time interval, i.e. increase between commutations of the phase winding 8.

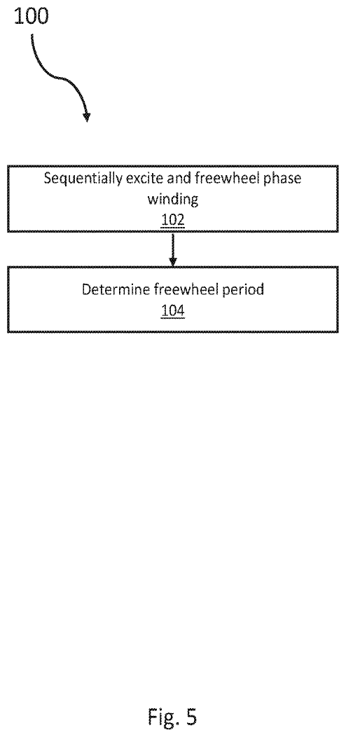

A method 100 that may mitigate for such current spikes is illustrated schematically in FIG. 5. The method 100 comprises sequentially exciting and freewheeling 102 a phase winding of the motor over a time interval between successive commutations of the phase winding, wherein exciting the phase winding comprises applying a voltage to the phase winding, and freewheeling comprises freewheeling the phase winding for a respective freewheel period in response to a phase current flowing through the phase winding reaching a current threshold. The method 100 comprises determining 104 the freewheel period such that the freewheel period increases between a start of the time interval and an end of the time interval.

In particular, as the sequence of excitation and freewheeling progresses through the time interval, the controller 12 determines the freewheel period such that the freewheel periods successively increase through the time interval. By applying successively increasing freewheel periods through the time interval, residual current in the phase winding 8 may be reduced along the time interval, which may reduce the risk of current spikes occurring, and provide a flatter current profile across the time interval. This may lead to increased motor reliability, and may improve battery lifetime and battery run time where the brushless permanent magnet motor 1 is implemented in a battery operated product. Utilising control methods to account for current spikes may be less costly than modifying hardware, which may reduce a cost of the brushless permanent magnet motor 1 relative to an arrangement that utilises hardware to account for current spikes.

The controller 12 determines the freewheel period to be applied based on the following set of equations:

$$FW = {FW}_{1} + {FW}_{2}$$

$${FW}_{1} = {m}_{1} \cdot {V}_{dc} + {C}_{1}$$

$${FW}_{2} = {m}_{2} \cdot time ( time , t = 0 to t = {t}_{1} )$$

where:
m1=gradient change of freewheel time with dc-link voltage
m2=gradient change of freewheel time with time
C1=y-intersection (freewheel time when dc-link voltage is zero)
t0=start of commutation period (half electrical period)
t1=end of commutation period (half electrical period)

Here FW₁ can be thought of as an initial, or baseline, freewheel period to be applied at the start of a time interval (e.g. where t=0, and hence where the FW₂ component of the freewheel period is zero). FW₁ is dependent on the DC link voltage applied to the phase winding 8, and hence the component of the freewheel period attributable to FW₁ will depend on the DC link voltage applied to the phase winding 8. The coefficients m₁ and c₁ are obtained from experimental tests and/or simulations, with m₁ comprising the gradient change of freewheel time with voltage, and c₁ being the y-axis intersection of a linear fit applied to a plot illustrating dependence of freewheel period with DC link voltage. In use the controller 12 can determine the present DC link voltage, and obtain m₁ and c₁ from memory, in order to determine the FW₁ factor to be applied. It will be appreciated that larger DC link voltages may results in larger currents within the phase winding 8, and hence that larger freewheel periods may be utilised in response to larger DC link voltages. In practice the values of m₁ and c₁ are dependent on a number of factors, including but not limited to inductance of the brushless permanent magnet motor 1, a resistance of the phase winding 8, a peak value of back EMF induced in the phase winding 8, and hardware configurations and dead times.

FW₂ can be thought of as a correction factor applied to the initial, or baseline, freewheel period given by FW₁, with the correction factor taking a value that is dependent on the time at which it is intended to apply the freewheel period within the time interval. Here m₂ is the gradient change of freewheel period with time for a given time interval, and is obtained from experimental tests and/or simulations. The value of m₂ increases for each successive time interval, and is stored in memory such that the controller 12 can obtain a value of m₂ for a given time interval.

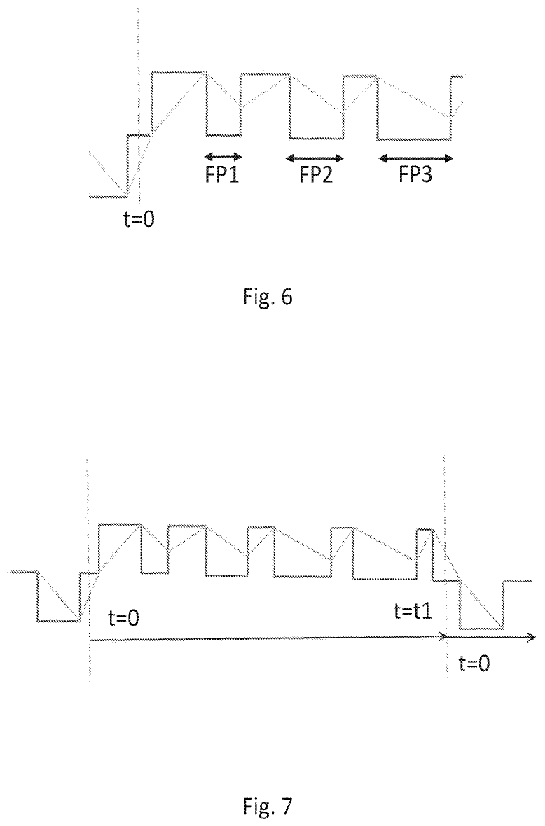

The “time” variable of FW₂ refers to the time at which the freewheel period is to be calculated. Such a time may be measured relative to initialisation of the brushless permanent magnet motor 1, or may be measured relative to the start of the time interval. Either way, the time value increases within the time interval. The controller 12 determines freewheel periods to be applied upon commutation, and where the phase current 22 hits the current threshold, with freewheel periods determined one period in advance. This is illustrated schematically in FIG. 6. Here a first freewheel period FP1 within the time interval is determined upon commutation of the phase winding, i.e. at the start of the time interval. A second freewheel period FP2 is determined when the phase current first hits the current threshold, i.e. at the start of the first freewheel period FP1, and a third freewheel period FP3 is determined when the phase current hits the current threshold for the second time, i.e. at the start of the second freewheel period FP2. It will be appreciated that as the time at which the freewheel period is determined increases along the time interval, so does FW₂, and hence so does the length of a freewheel period.

It will also be appreciated that the maximum value of “time” variable within a time interval decreases for successive time intervals, given that the rotor 2 is accelerating. However, the value of m₂ is such that freewheel periods increase in length in successive time intervals.

Schematic voltage and current waveforms for a time interval where increasing freewheel periods are used are illustrated in FIG. 7. As illustrated, the freewheel periods increase in length along the time interval, which helps to reduce current peaks and produce a flatter current profile. This may lead to increased motor reliability, and may improve battery lifetime and battery run time where the brushless permanent magnet motor 1 is implemented in a battery operated product.

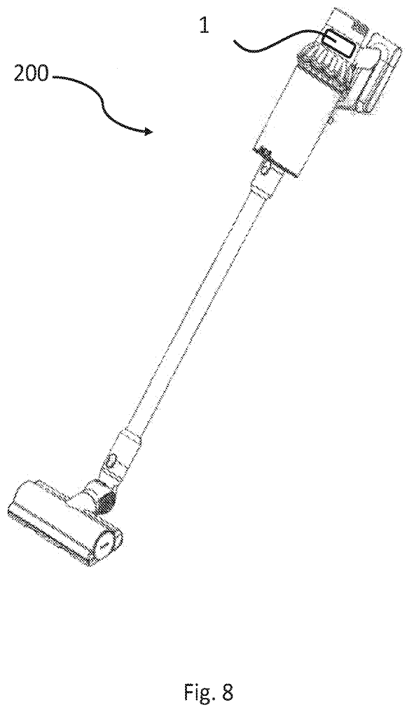

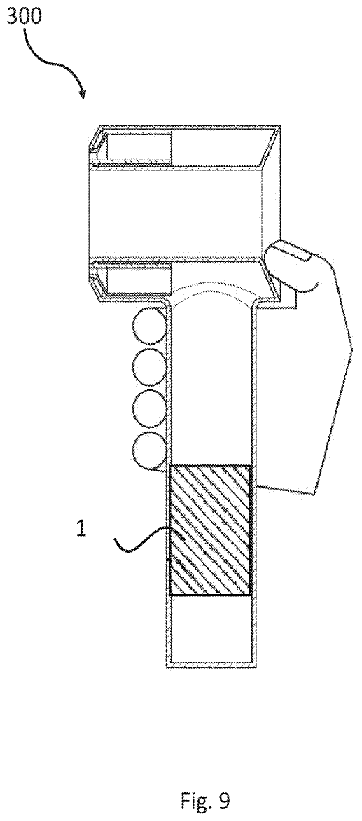

A vacuum cleaner 200 comprising the brushless permanent magnet motor 1 is illustrated schematically in FIG. 8, and a haircare appliance 300 comprising the brushless permanent magnet motor 1 is illustrated schematically in FIG. 9.

1. A method of controlling a brushless permanent magnet motor, the method comprising:
sequentially exciting and freewheeling a phase winding of the motor over a time interval between successive commutations of the phase winding, wherein exciting the phase winding comprises applying a voltage to the phase winding, and wherein freewheeling comprises freewheeling the phase winding for a respective freewheel period in response to a phase current flowing through the phase winding reaching a current threshold; and
determining the freewheel period such that the freewheel period increases between a start of the time interval and an end of the time interval.

2. A method as claimed in claim 1, wherein determining the freewheel period comprises determining the freewheel period such that the freewheel period increases sequentially within the time interval.

3. The method as claimed in claim 1, further comprising determining an initial freewheel period within the time interval based at least in part on a DC link voltage applied to the phase winding.

4. The method as claimed in claim 1, wherein a difference between a previously determined freewheel period and a next sequential freewheel period increases within the time interval.

5. The method as claimed in claim 4, wherein the difference is determined based at least in part on a time at which the next sequential freewheel period occurs within the time interval.

6. The method as claimed in claim 1, wherein the method further comprises, within the time interval;
measuring for each excitation of the phase winding, a parameter that depends on a rate of change of current in the phase winding during excitation or freewheeling;
comparing a most recent parameter to a previous sequential parameter, wherein a difference between the most recent measured parameter and the previous sequential parameter is below a threshold value;
determining that a rotor of the brushless permanent magnet motor is at a pre-determined position; and
in response to determining that the rotor is at the predetermined position, commutating the phase winding.

7. The method as claimed in claim 1, wherein the sequentially exciting and freewheeling of the phase winding of the motor is conducted over a plurality of sequential time intervals, each time interval comprising a time interval between successive commutations of the phase winding, wherein a different polarity of voltage pulse is applied to the phase winding in two adjacent time intervals, and wherein at least some freewheel periods of a later one of the two adjacent time intervals are greater than at least some freewheel periods of an earlier one of the two adjacent time intervals.

8. The method as claimed in claim 7, further comprising resetting the freewheel period at the end of each time interval.

9. The method as claimed in claim 1, wherein the method occurs during acceleration of the brushless permanent magnet motor.

10. A brushless permanent magnet motor comprising a phase winding, and a controller configured to perform the method as claimed in claim 1.

11. The brushless permanent magnet motor as claimed in claim 10, further comprising an inverter and a current sensor, wherein the current sensor is located on a low-side of the inverter.

12. The brushless permanent magnet motor as claimed in claim 11, wherein freewheeling comprises freewheeling around the low-side of the inverter.

13. A data carrier comprising machine-readable instructions for the operation of one or more controllers of a brushless permanent magnet motor to perform the method as claimed in claim 1.

14. A vacuum cleaner comprising the brushless permanent magnet motor as claimed claim 10.

15. A haircare appliance comprising the brushless permanent magnet motor as claimed in claim 10.
